(19) United States
(12) Patent Application Publication
(10) Pub. No.: US 2012/0064414 A1
(43) Pub. Date: Mar. 15, 2012

(54) PRODUCING SOLVENT MIXTURES HAVING A LOW WATER CONTENT

(75) Inventors: Klaus Leitner, Ludwigshafen (DE); Itamar Michael Malkowsky, Speyer (DE); Florian Stecker, Mannheim (DE); Wunibald Kippenberger, Ludwigshafen (DE); Markus Hummelsberger, Mannheim (DE); Christian Seitz, Heidelberg (DE); Mariella Schütz, Mannheim (DE); Carsten Süling, Frankenthal (DE)

(73) Assignee: BASF SE, Ludwigshafen (DE)

(21) Appl. No.: 13/226,925

(22) Filed: Sep. 7, 2011

Related U.S. Application Data
(60) Provisional application No. 61/381,454, filed on Sep. 10, 2010.

(51) Int. Cl. H01M 10/056

(52) U.S. Cl. 429/331; 429/330; 429/332

(57) ABSTRACT

A process for producing a solvent mixture comprising
(A) at least one compound of formula (I)

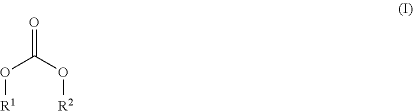

(B) at least one compound of formula (II a) or (II b)

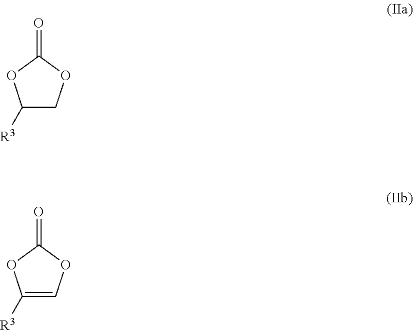

(C) optionally at least one additive selected from aromatic compounds, sultones and exo-methylene ethylene carbonates, melamine, urea, organic phosphates and halogenated organic carbonates,
(D) optionally at least one lithium salt,
   and from 3 to 30 weight ppm of water,
   which process comprises
(a) components (A), (B) and, if used, (C) being mixed with one another,
(b) dried over at least one ion exchanger or molecular sieve,
(c) separated from ion exchanger or, respectively, molecular sieve, and
(d) at least one lithium salt, if used, being added,
   where the variables are defined as follows:
R¹, R² are each the same or different and selected from C₁-C₄-alkyl,
R³ is selected from hydrogen and C₁-C₄-alkyl.

The present invention relates to processes for producing solvent mixtures comprising
(A) at least one compound of formula (I)

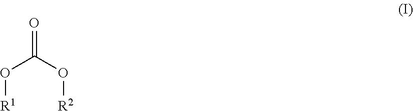

(B) at least one compound of formula (II a) or (II b)

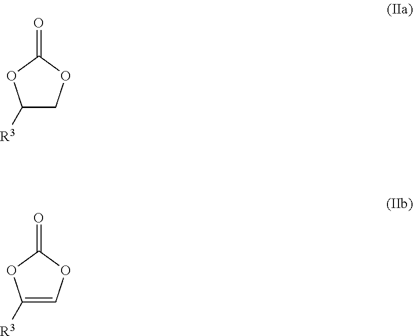

(C) optionally at least one additive selected from aromatic compounds, sultones and exo-methylene ethylene carbonates, organic phosphates and halogenated organic carbonates,
(D) optionally at least one lithium salt,
   and from 3 to 30 weight ppm of water,
   which processes comprise
   i. components (A), (B) and, if used, (C) being mixed with one another,
   ii. dried over at least one ion exchanger or molecular sieve,
   iii. separated from ion exchanger or, respectively, molecular sieve, and
   iv. at least one lithium salt, if used, being added,
      where the variables are defined as follows:
      R¹, R² are each the same or different and selected from C₁-C₄-alkyl,
      R³ is selected from hydrogen and C₁-C₄-alkyl.

In an alternative variant, the invention relates to a process for producing solvent mixtures where the drying of the individual components (A), (B) and, if used, (C), or of individual of these components takes place before they are mixed. Accordingly the invention also relates to processes for producing solvent mixtures comprising
(A) at least one compound of formula (I)

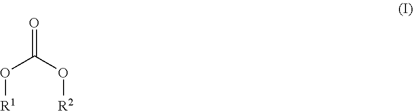

(B) at least one compound of formula (II a) or (II b)

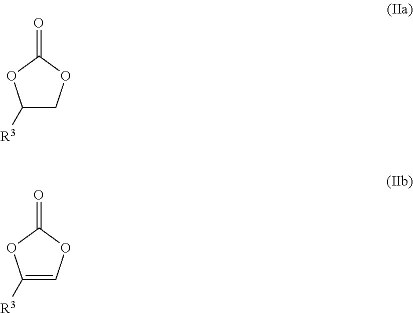

(C) optionally at least one additive selected from aromatic compounds, sultones and exo-methylene ethylene carbonates, organic phosphates, melamine, urea, and halogenated organic carbonates,
(D) optionally at least one lithium salt,
   and from 3 to 30 weight ppm of water,
   which process comprises
   i. at least one of the components (A), (B) and, if used, (C) being dried, each individually, over at least one ion exchanger or molecular sieve,
   ii. ion exchanger or, respectively, molecular sieve, being separated off from the components dried in step (i), and
   iii. components (A), (B) and, if used, (C) and, if used, at least one lithium salt being mixed with one another,
      where the variables are defined as follows:
      R¹, R² are each the same or different and selected from C₁-C₄-alkyl,
      R³ is selected from hydrogen and C₁-C₄-alkyl.

The present invention further relates to solvent mixtures comprising

(A) at least one compound of the formula (I),
(B) at least one compound of formula (II a) or (II b),
(C) optionally at least one additive selected from aromatic compounds, sultones and exo-methylene ethylene carbonates, organic phosphates and halogenated organic carbonates
(D) and optionally at least one lithium salt
and from 3 to 30 weight ppm of water,
and also to the use of solvent mixtures according to the present invention in lithium ion batteries.

The search for ways to store electric energy efficiently has been going on for years. Efficient storage of electric energy would allow electric energy to be generated when it is advantageous and used when needed.

Accumulators, for example lead accumulators and nickel-cadmium accumulators, have been known for many decades. The known lead accumulators and nickel-cadmium accumulators have the disadvantages of a comparatively low energy density and of a memory effect which reduces the rechargeability and hence the useful life of lead accumulators and nickel-cadmium accumulators.

Lithium ion accumulators, frequently also referred to as lithium ion batteries, are used as an alternative. They provide higher energy densities than accumulators based on lead or comparatively noble heavy metals.

Since many lithium ion batteries utilize metallic lithium, they are water sensitive. Water is therefore out of the question as a solvent for the lithium salts used in lithium ion batteries. Instead, organic carbonates, ethers and esters are used as sufficiently polar solvents. The literature accordingly recommends using water-free solvents for the electrolytes, see for example WO 2007/049888.

Water-free solvents, however, are inconvenient to produce and process. Numerous solvents inherently useful for lithium ion batteries comprise in the order of 100 ppm or more of water. However, such high proportions of water are unacceptable for most lithium ion batteries. The problem of providing sufficiently suitable solvents for lithium ion batteries is complicated by the fact that most state of the art lithium ion batteries comprise not a single solvent but solvent mixtures of which some differ greatly in their activity with driers.

The present invention has for its object to provide solvent mixtures suitable as electrolytes in lithium ion batteries. The present invention further has for its object to provide a process for producing solvent mixtures suitable for lithium ion batteries. The present invention finally has for its object to provide lithium ion batteries having good performance characteristics.

We have found that this object is achieved by the processes defined at the beginning.

For the purposes of the present invention, lithium ion accumulators are referred to as lithium ion batteries.

The processes of the present invention provide solvent mixtures comprising
(A) at least one compound of formula (I),

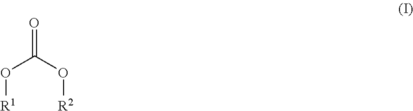

(B) at least one compound of formula (II a) or (II b),

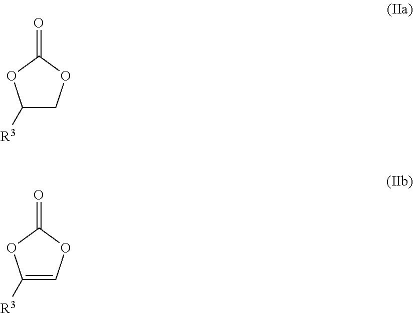

and from 3 to 30 weight ppm of water, preferably from 5 to 25 weight ppm.

The variables in the formulae are defined as follows:
R¹, R² are each the same or different and are selected from C₁-C₄ alkyl, for example methyl, ethyl, n-propyl, isopropyl, n-butyl, isobutyl, sec-butyl, preferably methyl or ethyl,
R³ is selected from C₁-C₄-alkyl, for example methyl, ethyl, n-propyl, isopropyl, n-butyl, isobutyl, sec-butyl, preferably methyl, and more particularly hydrogen.

One embodiment of the present invention comprises compound of formula (I) and compound(s) of formula (II a) and (II b) in a weight ratio ranging from 1:10 to 10:1, and preferably from 3:1 to 1:1.

Preferred compounds of formula (I) are dimethyl carbonate, diethyl carbonate and methyl ethyl carbonate and mixtures thereof, i.e., mixtures of at least two of the recited compounds dimethyl carbonate, diethyl carbonate and methyl ethyl carbonate.

In one embodiment of the present invention, solvent mixture obtained according to the present invention comprises two or more compounds of formula (I), for example diethyl carbonate and methyl ethyl carbonate.

In one embodiment, solvent mixture obtained according to the present invention comprises at least one compound of formula (II a), but no compound of formula (II b). In another embodiment of the present invention, solvent mixture obtained according to the present invention comprises at least one compound of formula (II b), but no compound of formula (II a). In another embodiment of the present invention, solvent mixture obtained according to the present invention comprises at least one compound of formula (II a) and at least one compound of formula (II b).

The proportions of water can be determined via various methods known per se. Karl Fischer titration, for example to DIN 51777 or ISO760: 1978, is particularly suitable.

Solvent mixtures obtained according to the present invention may comprise further constituents, for example
(C) at least one additive selected from aromatic compounds, sultones and exo-methylene ethylene carbonates, halogenated organic carbonates, organic phosphates, and/or
(D) at least one lithium salt.

Accordingly, “solvent mixture” for the purposes of the present invention applies not just to salt-free solvent mixtures but also to solutions of lithium salts in solvent mixtures.

Examples of aromatic compounds suitable as an additive are biphenyl, cyclohexylbenzene and 1,4-dimethoxybenzene.

Sultones may be substituted or unsubstituted. Examples of suitable sultones are butanesultone and propylenesulfone, formula (III),

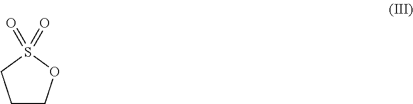

and particularly sultones having at least one C—C double bond per molecule. An example of a substituted sultone is 1-phenyl-1,3-butanesultone.

Examples of exo-methylene ethylene carbonates are particularly compounds of formula (IV)

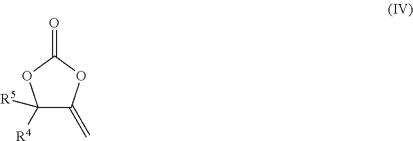

where in each case R⁴ and R⁵ can be different or the same and are each selected from C₁-C₁₀ alkyl and hydrogen. In one preferred embodiment, R⁴ and R⁵ are both methyl.

Halogenated, more particularly fluorinated, organic carbonates comprise cyclic or noncyclic organic carbonates having at least one halogen atom per molecule, preferably one or two halogen atoms per molecule. The halogen atoms are preferably chlorine and more preferably fluorine. Examples are fluoroethylene carbonate and difluoroethylene carbonate:

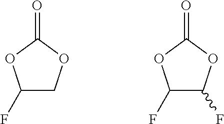

Organic phosphates comprise triesters of phosphoric acid with one or more organic alcohols, preferably with one organic alcohol. Useful organic alcohols include for example alkanols, substituted or unsubstituted, and phenols, substituted or unsubstituted. Preferred examples of organic phosphates are tris(chloroethyl) phosphate, tris(3-chloropropyl) phosphate, tris(2-isopropyl) phosphate, triphenyl phosphate, tricresyl phosphate, tris(ω,ω′-dichloroisopropyl) phosphate, tris(2-ethylhexyl) phosphate, resorcinol bis(diphenyl phosphate), mono-, bis- and tris(isopropylphenyl) phosphates (“isopropylated triphenyl phosphate”) and bisphenol A diphenyl phosphate. Organic phosphates can serve as flame retardants.

Melamine and urea are examples of other suitable flame retardants.

One embodiment of the present invention comprises adding altogether from zero to 30% by weight of additive(s) (C), based on total solvent mixture obtained according to the present invention, preference being given to a range from 1% to 10% by weight.

In one variant, the process provided by the present invention to produce solvent mixtures comprises at least the following three steps:
(a) Mixing the aforementioned components (A), (B) and, if used, (C) with one another by stirring for example. Pre-dried or commercially available components (A), (B) and, if used, (C) can be used.
(b) Drying the mixture over at least one ion exchanger or preferably molecular sieve.
(c) Separating the dried solvent mixture from ion exchanger or molecular sieve.
(d) A fourth, optional step of adding at least one lithium salt or component (C).

In another variant, the process provided by the present invention to produce solvent mixtures comprises at least the following three steps:
i. drying at least one of the components (A), (B) and, if used, (C), each individually, over at least one ion exchanger or molecular sieve,
ii. separating off ion exchanger or, respectively, molecular sieve, from the components dried in step (i), and
iii. mixing components (A), (B) and, if used, (C) and, if used, at least one lithium salt with one another.

It is not necessary to submit all components (A), (B) and, if used, (C) to the drying step in this variant. Drying of one, more than one or all of these components must be carried out such that, after mixing, the solvent mixture of these components and the at least one lithium salt (D), if used, includes the inventive proportion of water.

The drying of individual components according to step (i) is carried out in a manner corresponding to the drying of the solvent mixture according to step (b). Likewise, separating the dried individual components from the ion exchanger or molecular sieve, according to step (ii) is carried out in a manner corresponding to the separation of the dried solvent mixture from the ion exchanger or molecular sieve according to step (c). Finally, mixing of the individual components according to step (iii) is carried out in a manner corresponding to the mixing according to step (a).

Steps (a), (b) and (c) will now be more particularly described.

Mixing the components (A), (B) and, if used, (C) can be done at any desired temperatures.

### Step (a):

One embodiment of the present invention comprises mixing at temperatures in the range from 10 to 100° C.

One embodiment of the present invention comprises mixing at a temperature at least 1° C. above the melting point of the highest melting component (A) or (B).

The upper temperature limit for the mixing operation is determined by the volatility of the most volatile component of the solvent mixture. Preference is given to mixing at a temperature below the boiling point of the most volatile component of the solvent mixture.

Mixing can be done at any desired pressure, and atmospheric pressure is preferred. The duration of mixing can be chosen for example in the range from 5 minutes up to 24 hours.

### Step (b):

Ion exchangers and molecular sieves are known as such.

Molecular sieves are hereinafter preferably chosen from natural and synthetic zeolites which can be in the form of spheres (beads), powders or rods. Preference is given to using 4 Å molecular sieve and more preferably 3 Å molecular sieve.

Ion exchangers can be used as shaped articles, for example in the form of beads or rods, as a powder or as a column. Preference is given to shaped articles such as beads in particular.

One embodiment of the present invention comprises using cationic ion exchangers.

In one embodiment of the present invention, ion exchanger or molecular sieve is selected from at least partially lithiated ion exchangers or, respectively, at least partially lithiated molecular sieves. At least partially lithiated ion exchangers comprise cationic ion exchangers where H⁺ and/or Na⁺ or K⁺ are very substantially replaced by Li+. In another embodiment of the present invention ion exchanger or molecular sieve is used which is not lithiated (not even partially).

One embodiment of the present invention comprises admixing a solvent mixture from step (a) with molecular sieve or preferably ion exchanger and allowing the molecular sieve or ion exchanger to act on the solvent mixture, for example by stirring the suspension of molecular sieve or ion exchanger in the solvent mixture—continuously or for certain intervals. Shaking or pumped circulation can also be used instead of stirring.

Another embodiment comprises letting ion exchanger/molecular sieve act on the solvent mixture by applying the solvent mixture to a column or a filter area comprising ion exchanger/molecular sieve as stationary phase, and then allowing the solvent mixture to pass through the column/filter, for example under the force of gravity or augmented by pumping.

Preference is given to letting ion exchanger or molecular sieve act on solvent mixture in the absence of chemical driers. Chemical driers for the purposes of the present invention are strongly acidic, alkaline or strongly reducing driers, more particularly selected from low molecular weight compounds, salts and elements. Known acidic driers include for example aluminum alkyls such as for example trimethylaluminum, also phosphorus pentoxide and concentrated sulfuric acid. Known basic driers include for example potassium carbonate and CaH₂. Known reducing driers include for example elemental sodium, elemental potassium and sodium-potassium alloy.

One embodiment of the present invention comprises conducting step (c) at a temperature in the range from 4 to 100° C., preferably in the range from 15 to 40° C. and more preferably in the range from 20 to 30° C.

In one embodiment of the present invention, the time for which ion exchanger or molecular sieve is allowed to act on the solvent mixture is in the range from a few minutes, for example at least 5 minutes, to several days, preferably not more than 24 hours and more preferably in the range from one to 6 hours.

In one embodiment of the present invention, ion exchanger or molecular sieve is used after packing into a column. Embodiments of this type are preferably operated at a linear flow rate (flow rate/column cross section of empty column) of 0.1-50 m/h and preferably 0.5-15 m/h.

During the practice of step (c) a little solvent mixture can be removed one or more times in order that the progress of drying may be tracked by means of Karl Fischer titration.

It is preferable to keep the stirring or shaking to a minimum. Excessively vigorous stirring/shaking can lead to partial disintegration of the molecular sieve or ion exchanger, and this may give rise to problems with removal by filtration.

The action of ion exchanger/molecular sieve provides for substantial removal from the solvent mixture of water and any traces of acid present. However, some water does remain in the solvent.

### Step (c)

After the action of molecular sieve or ion exchanger on the solvent mixture it is necessary to separate off the molecular sieve or ion exchanger. The separating off in step (c) can be accomplished by distilling or decanting off the solvent mixture or preferably by filtration.

Step (c) is preferably practiced under inert gas, for example under dried nitrogen or under dried argon. Instead of dried inert gas, however, step (c) can also be carried out under dried air.

Choosing the version in which solvent mixture is applied to a column or filter surface comprising ion exchanger/molecular sieve as stationary phase and then allowing the solvent mixture to pass through the column/filter amounts to practicing step (b) and step (c) simultaneously, which is likewise within the realm of the present invention.

When using molecular sieve/ion exchanger in the form of beads or rods for example, the pore diameter of the filter material is preferably adapted to the average particle diameter of molecular sieve/ion exchanger.

One version comprises adding one or more components (C) as a whole or in part after step (c).

### Step (d)

If desired, at least one lithium salt (D) can be added and preferably dissolved in a step (d). Suitable lithium salts (D) must be sufficiently soluble in the solvent mixture obtained according to the present invention, for example to at least 1 g/l at room temperature. Examples of suitable lithium salts (D) are LiPF₆, LiBF₄, LiClO₄, LiAsF₆, LiCF₃SO₃, LiC(CₙF₂ₙ₊₁SO₂)₃, lithium bisoxalatoborate, lithium difluorbisoxalatoborate, lithium imides such as LiN(CₙF₂ₙ₊₁SO₂)₂, where n is an integer from 1 to 20, LiN(SO₂F)₂, Li₂SiF₆, LiSbF₆, LiAlCl₄, and salts of the general formula (CₙF₂ₙ₊₁SO₂)ₘXLi, where m is as defined below:

m=1, when X is selected from oxygen and sulfur,
m=2, when X is selected from nitrogen and phosphorus, and
m=3, when X is selected from carbon and silicon.

Preferred conducting salts are selected from LiC(CF₃SO₂)₃, LiN(CF₃SO₂)₂, LiPF₆, LiBF₆ and LiClO₄, and particular preference is given to LiPF₆ and LiN(CF₃SO₂)₂.

In addition to adding lithium salt (D) in step (d) the solvent mixture can be heated and/or subjected to further measures that promote the dissolving of lithium salt (D) for example shaking, stirring or pumped circulation.

One embodiment comprises adding from 1% to 30% by weight of lithium salt (D), based on total solvent mixture obtained according to the present invention, preference being given to the range from 10% to 20% by weight.

In one version of the present invention, one or more additives (C) can be added after practice of steps (a) to (c). However, this is sensible only when the additives concerned do not raise the water content of solvent mixture obtained according to the present invention to over 30 weight ppm in total.

In one version of the present invention, at least one further component (B) can be added beyond the component(s) (B) initially mixed with component(s) (A).

Solvent mixtures obtained by the process of the present invention are very suitable in and for producing lithium ion batteries.

The present invention further provides solvent mixtures comprising
(A) at least one compound of formula (I)

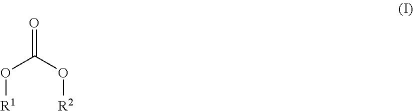

(B) at least one compound of formula (II a) or (II b),

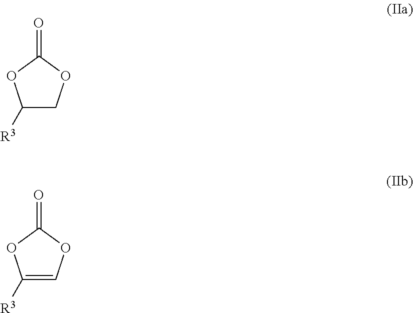

(C) optionally at least one additive selected from aromatic compounds, sultones, exo-methylene ethylene carbonates, organic phosphates, melamine, urea and halogenated organic carbonates, in particular one or more fluorinated organic carbonates,
(D) optionally at least one lithium salt,
   and from 3 to 30 weight ppm of water, preferably from 5 to 25 weight ppm of water,
   where the variables are defined as follows:
   R¹, R² are each the same or different and selected from C₁-C₄-alkyl,
   R³ is selected from hydrogen and C₁-C₄-alkyl.

Solvent mixtures according to the present invention are advantageously obtainable by the process described above.

The components (A), (B) and water and also the optional components (C) and (D) are described above.

In one embodiment of the present invention, solvent mixtures according to the present invention comprise no measurable fractions of protic organic compounds such as for example alcohols or primary or secondary amines.

In one embodiment of the present invention, solvent mixtures according to the present invention comprise not more than 50 weight ppm, preferably not more than 20 weight ppm and more preferably not more than 10 weight ppm of protic organic compounds.

In one embodiment of the present invention, solvent mixture according to the present invention comprises altogether from 9% to 90% by weight of compound(s) of formula (I), preferably from 20% to 80% by weight,

altogether from 9% to 90% by weight of compound(s) of formula (II a) or (II b), preferably from 20% to 80% by weight,
from 3 to 30 weight ppm of water, preferably from 5 to 25 weight ppm,
from zero to altogether 30% by weight of additive(s) (C), preferably from 1% to 10% by weight,
from zero to altogether 30% by weight and preferably from 10% to 20% by weight of lithium salt (D).

In one embodiment of the present invention, compound of formula (I) is selected from dimethyl carbonate, diethyl carbonate, and methyl ethyl carbonate and mixtures thereof, i.e., mixtures of at least two of the recited compounds dimethyl carbonate, diethyl carbonate and methyl ethyl carbonate.

In one embodiment of the present invention, solvent mixture according to the present invention comprises at least one compound of formula (II a) and at least one compound of formula (II b).

In one embodiment of the present invention, solvent mixture according to the present invention comprises at least one lithium salt (D) selected from LiPF₆, LiBF₄, LiN(CF₃SO₂)₂, LiClO₄, lithium bisoxalatoborate, lithium difluorooxalatoborate, LiAsF₆, LiN(FSO₂)₂, LiC(CF₃SO₂)₃, LiN(C₂F₅SO₂)₂, preference being given to LiPF₆, LiBF₄, LiN(CF₃SO₂)₂ and lithium bisoxalatoborate (LiBOB).

Lithium salt (D) can be added to the solvent mixture in concentrations of 0.1 M to 3 M and preferably 0.5 M to 1.5 M.

Solvent mixtures according to the present invention in one embodiment of the present invention comprise altogether less than 50 weight ppm of decomposition products of compounds of formulae (I), (II a) and/or (II b), for example aliphatic C₁-C₄-alkanols, ethylene glycol or compounds of the general formula

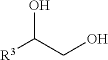

in each of which R³ is as described above. Decomposition products such as for example aliphatic C₁-C₄-alkanols, ethylene glycol or compounds of the above formulae are detectable by gas chromatography for example.

Solvent mixtures according to the present invention in a preferred embodiment comprise no measurable proportions of decomposition products in compounds of formulae (I), (II a) and/or (II b).

Solvent mixtures according to the present invention are very useful in and for producing lithium ion batteries. The present invention accordingly further provides for the use of solvent mixtures according to the present invention in or for producing lithium ion batteries. The present invention further provides lithium ion batteries comprising a solvent mixture according to the present invention. Lithium ion batteries according to the present invention display good cyclability and excellent stability. The lithium ion batteries utilize such solvent mixtures according to the present invention as comprise at least one lithium salt (D).

Lithium ion batteries according to the present invention may comprise for example one or more cathodes based on transition metal mixed oxides, for example based on LiMnO₂, LiCoO₂, LiNiO₂, based on Li_{1+w}(NiₐCo_{b}Mn_{1-a-b})_{1-w}O₂, where w can be in the range from zero to 0.2, preferably up to 0.1, a and b are selected from numbers in the range from zero to 1 subject to the condition

a+b≦1.

Cathodes based on transition metal mixed oxides may further include for example carbon in an electrically conductive form, for example as carbon black, soot, graphite, graphene or as carbon nanotubes.

Cathodes in batteries according to the present invention may further comprise for example a binder, for example a polymeric binder. Particularly suitable polymeric binders are polyvinylidene fluoride (PVdF), polytetrafluoroethylene, copolymers of tetrafluoroethylene and hexafluoropropylene, copolymers of tetrafluoroethylene and vinylidene fluoride and polyacrylonitrile.

Lithium ion batteries according to the present invention may further comprise an anode that is composed of materials known per se, preferably substantially graphite. Lithium ion batteries according to the present invention may further comprise customary constituents, for example one or more separators, one or more current collectors and a casing.

Lithium ion batteries according to the present invention in another embodiment of the present invention can be selected from so-called lithium air batteries, i.e., batteries based on the principle of the reversible reaction of lithium with atmospheric oxygen to form an oxide or peroxide, i.e., to form Li₂O or Li₂O₂. Lithium ion batteries according to the present invention in another embodiment of the present invention may be selected from lithium sulfur batteries, i.e., batteries based on the reaction of sulfur via polysulfide ions to S²⁻, which are reoxidized when the cell is charged.

The invention is illustrated by working examples.

Values in ppm are all based on weight ppm. Determination was by Karl Fischer titration to DIN 51777 or ISO760: 1978 with coulometric detection.

### I. Producing Inventive Lithium Ion Batteries

### I.1 Producing Inventive Solvent Mixture LGM.1

On an HS1000 filter, 37 kg of a 3 Å molecular sieve, zeolite based on aluminosilicate, bead form, average diameter 16 mm, commercially available as Sylobead® MS 564 C, was activated by heating to 150° C. at 10 bar for 114 hours, on a filter on the filter surface of a suction filter.

The following were mixed at 25° C. under dry argon in a stirred vessel connected to the suction filter in a pumped circuit:

78.2 kg of ethylene carbonate (II. a.1) water content: 20 ppm
97.6 kg of ethyl methyl carbonate (I.1), water content: 53 ppm

The thus obtainable mixture of organic carbonates was circulation pumped via the molecular sieve in the suction filter. An inventive solvent mixture, the water content of which was determined as 15 ppm, was obtained after 7.5 hours. It was used to dissolve 31.0 kg of LiPF₆ and 4.4 kg of vinylene carbonate to obtain an inventive solvent mixture LGM.1 comprising lithium salt.

### I.2 Producing Electrodes for Inventive Lithium Ion Batteries

### I.2.1 Producing a Cathode

The following were mixed in a mortar under argon:

### 89 g of Li_{1.01}Ni_{0.5}CO_{0.2}Mn_{0.3}O_{2.01}.

5 g of PVdF (from Aldrich),
3 g of carbon black (Super-P®, from Timcal)
3 g of carbon black (KS6, from Timcal)
with the addition of 100 g of NMP, until a honeylike suspension had formed. The honeylike suspension was blade coated onto aluminum foil and dried at 120° C. for 16 hours. The layer thickness of the dried cathode mass thus obtainable was 40 μm. The layer was calendered to compress it by 25% to 30 μm. Next, electrodes measuring 50 mm×50 mm were cut out, weighed, welded to an Al current collector and dried once more in vacuo at 120° C.

The active mass determined for the cathode was 225 mg.

### I.2.2 Producing an Inventive Lithium Ion Battery

The dried electrodes from I.2.1 were transferred into an argon-filled glovebox in which the following operations were conducted: the anode was placed with the coated side face up on a heat-sealable PET/Al/PE composite film (NEFAB) and bedrizzled with about 500 μL of LGM.1. A polyolefin separator (Celgard) measuring 55 mm×55 mm was placed without folds in the center of the electrolyte-moistened anode and likewise bedrizzled with LGM.1. Next, the cathode was likewise bedrizzled with LGM.1 and placed with the coated side down in the center of the separator. Finally, excess LGM.1 was wiped off and the stack (PET/Al/PE composite film, anode, separator, cathode) was covered with a heat-sealable PET/Al/PE composite film and sealed at the four edges using a heat-sealing apparatus.

An inventive lithium ion battery LIB.1 was obtained.

### II. Electrochemical Characterization of Inventive Lithium Ion Battery LIB.1:

LIB.1 was taken out of the glovebox and charged and discharged (while measuring the capacity of the cell) by means of a battery test system (MACCOR) at 25° C. using the following settings:

charging: from 3.2 V at the reported C rate to 4.2 V, then maintain at 4.2 V for 1 h.
discharging: from 4.2 V at the stated C rate to 3.2 V.
current: cycles 1 and 2 at 0.1 C (forming), cycles 3 to 300 at 0.5 C. The specific capacity C was set at a nominal 139 mAh/g.

### Result:

The cycle-dependent capacity of LIB.1 and also the charging/discharging efficiency is depicted in FIG. 1. It is evident that the capacity of 135 mAh/g (based on the cathode material) measured in the 3rd cycle scarcely decreased in the course of charging and discharging. After 300 cycles, the capacity was still 128 mAh/g. This corresponds to a decrease of merely 5%. Charging and discharging took place at high efficiency (>99.95%) after just a few cycles.

We claim:

1. A process for producing a solvent mixture comprising
(A) at least one compound of formula (I) 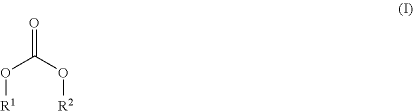
(B) at least one compound of formula (II a) or (II b) 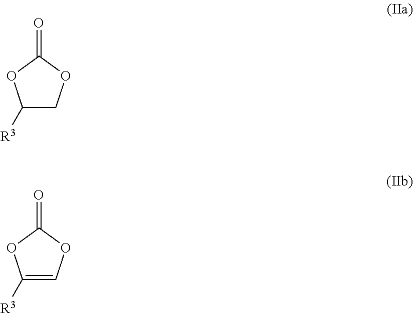
(C) optionally at least one additive selected from aromatic compounds, sultones and exo-methylene ethylene carbonates, organic phosphates, melamine, urea and halogenated organic carbonates,
(D) optionally at least one lithium salt,
and from 3 to 30 weight ppm of water,
which process comprises
(a) components (A), (B) and, if used, (C) being mixed with one another,
(b) dried over at least one ion exchanger or molecular sieve,
(c) separated from ion exchanger or, respectively, molecular sieve, and
(d) at least one lithium salt, if used, being added,
where the variables are defined as follows:
R¹, R² are each the same or different and selected from C₁-C₄-alkyl,
R³ is selected from hydrogen and C₁-C₄-alkyl.

2. A process for producing a solvent mixture comprising
(A) at least one compound of formula (I) 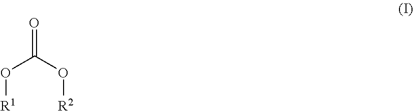
(B) at least one compound of formula (II a) or (II b) 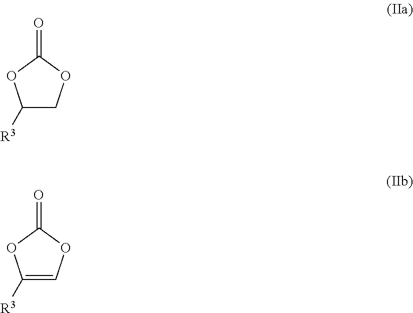
(C) optionally at least one additive selected from aromatic compounds, sultones and exo-methylene ethylene carbonates, organic phosphates, melamine, urea, and halogenated organic carbonates,
(D) optionally at least one lithium salt,
and from 3 to 30 weight ppm of water,
which process comprises
i. at least one of the components (A), (B) and, if used, (C) being dried, each individually, over at least one ion exchanger or molecular sieve,
ii. ion exchanger or, respectively, molecular sieve, being separated off from the components dried in step (i), and
iii. components (A), (B) and, if used, (C) and, if used, at least one lithium salt being mixed with one another,
where the variables are defined as follows:
R¹, R² are each the same or different and selected from C₁-C₄-alkyl,
R³ is selected from hydrogen and C₁-C₄-alkyl.

3. The process according to claim 1 or 2 wherein the solvent mixture includes from 5 to 25 weight ppm of water.

4. The process according to any one of claims 1 to 3 wherein ion exchanger or molecular sieve is separated off in step (c) by filtration.

5. The process according to any one of claims 1 to 4 wherein ion exchanger or molecular sieve is selected from at least partially lithiated ion exchangers or, respectively, at least partially lithiated molecular sieves.

6. The process according to any one of claims 1 to 4 wherein ion exchanger or molecular sieve is selected from unlithiated ion exchangers or, respectively, unlithiated molecular sieves.

7. The process according to any one of claims 1 to 6 wherein compound of formula (I) is selected from dimethyl carbonate, diethyl carbonate, methyl ethyl carbonate and mixtures thereof.

8. The process according to any one of claims 1 to 7 wherein at least one compound of formula (II a) and at least one compound of formula (II b) are chosen.

9. A solvent mixture comprising
a. at least one compound of formula (I) 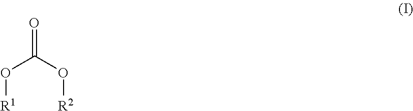
b. at least one compound of formula (II a) or (II b) 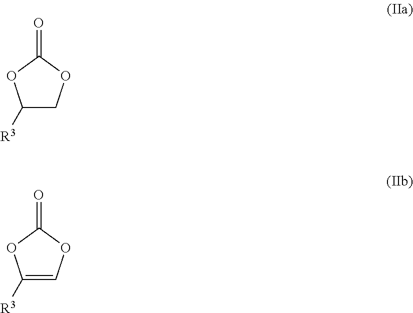
c. optionally at least one additive selected from aromatic compounds, sultones and exo-methylene ethylene carbonates, organic phosphates and halogenated organic carbonates,
d. optionally at least one lithium salt,
and from 3 to 30 weight ppm of water,
where the variables are defined as follows:
R¹, R² are each the same or different and selected from C₁-C₄-alkyl,
R³ is selected from hydrogen and C₁-C₄-alkyl.

10. The solvent mixture according to claim 9 including from 5 to 25 weight ppm of water.

11. The solvent mixture according to claim 9 or 10 wherein compound of formula (I) is selected from dimethyl carbonate, diethyl carbonate, methyl ethyl carbonate and mixtures thereof.

12. The solvent mixture according to any one of claims 9 to 11 comprising at least one compound of formula (II a) and at least one compound of formula (II b).

13. The solvent mixture according to any one of claims 9 to 12 wherein lithium salt (D) is selected from LiPF₆, LiBF₄, LiN(CF₃SO₂)₂ and lithium bisoxalatoborate.

14. The use of a solvent mixture according to any one of claims 9 to 13 in the manufacture of a lithium ion battery.

15. A lithium ion battery comprising a solvent mixture according to any one of claims 9 to 13.
